(19) United States
(12) Patent Application Publication
(10) Pub. No.: US 2007/0062346 A1
(43) Pub. Date: Mar. 22, 2007

(54) Hand tool having a pivotable connection end and replaceable function head

(76) Inventor: Chih-Ching Hsieh, Taichung (TW)

Correspondence Address: PHILLIP LIU, 6980, WHITEOAK DR., RICHMOND, BC, V7EAZ9, CA

(21) Appl. No.: 11/228,439

(22) Filed: Sep. 19, 2005

(51) Int. Cl. B25B 23/16; B25G 1/00

(52) U.S. Cl. 81/177.7; 81/177.85

(57) ABSTRACT

A hand tool includes a handle and a connection end is pivotably connected to an end of the handle. The connection end has a recess defined therein and a function end has an insertion which is removably inserted into the recess of the connection end.

### FIELD OF THE INVENTION

The present invention relates to a hand tool having a pivotable connection end and a function head can be replaceably connected to the connection end.

### BACKGROUND OF THE INVENTION

Some conventional hand tools 90 known to applicant are shown in FIGS. 11 to 13 and generally include a handle 92 with a function head 91 pivotably connected to the handle 92, wherein the function head 91 can be a wrench as shown in FIG. 11, a ratchet driving head as shown in FIG. 12 or a ratchet box end as shown in FIG. 13. Although the function heads 91 can be pivoted about an axis perpendicular to the longitudinal axis of the handle 91, they cannot be replaceable and has a fixed function so that the user has to carry different types of the hand tools 90 and choose one of them according to the object to be tightened or loosened. In addition, the size of each of the function heads 92 is fixed so that the users have to prepare different sizes of the same type of function head.

The present invention intends to provide a hand tool wherein the function head can be pivoted relative to the handle and different function heads can be replaceable as needed.

### SUMMARY OF THE INVENTION

The present invention relates to a hand tool which comprises a handle having a connection end pivotably connected to an end of the handle and a recess is defined in the connection end. A function end has an insertion which is removably inserted into the recess of the connection end.

The primary object of the present invention is to provide a hand tool wherein the function head can be replaced and pivoted relative to the handle so as to meet different needs.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a connection end and the handle of the hand tool of the present invention;

FIG. 2 is an exploded view to show a function head and the handle with the connection end of the hand tool of the present invention;

FIG. 3 is a perspective view to show the hand tool of the present invention;

FIG. 4 shows another function head and the hand tool of the present invention;

FIG. 5 shows a ratchet function head and the hand tool of the present invention;

FIG. 6 shows yet function head and the hand tool of the present invention;

FIG. 7 shows a further embodiment of a function head and the hand tool of the present invention;

FIG. 8 is a side cross sectional view to show a function head is connected to the connection end;

FIG. 9 shows that the function head can be pivoted relative to the handle;

FIG. 10 shows that the hand tool reaches an object located in a concavity, and

FIGS. 11-13 show three different conventional hand tools.

### DETAILED DESCRIPTION OF THE PREFERRED EMBODIMENT

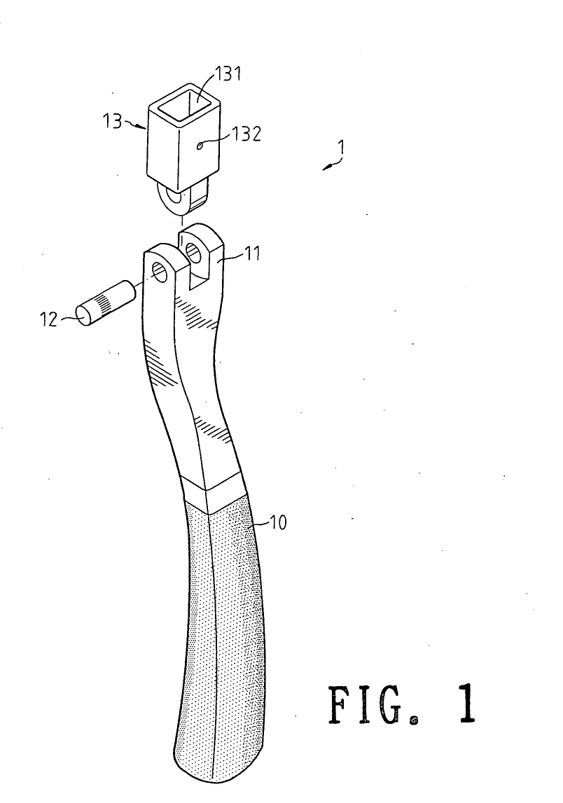

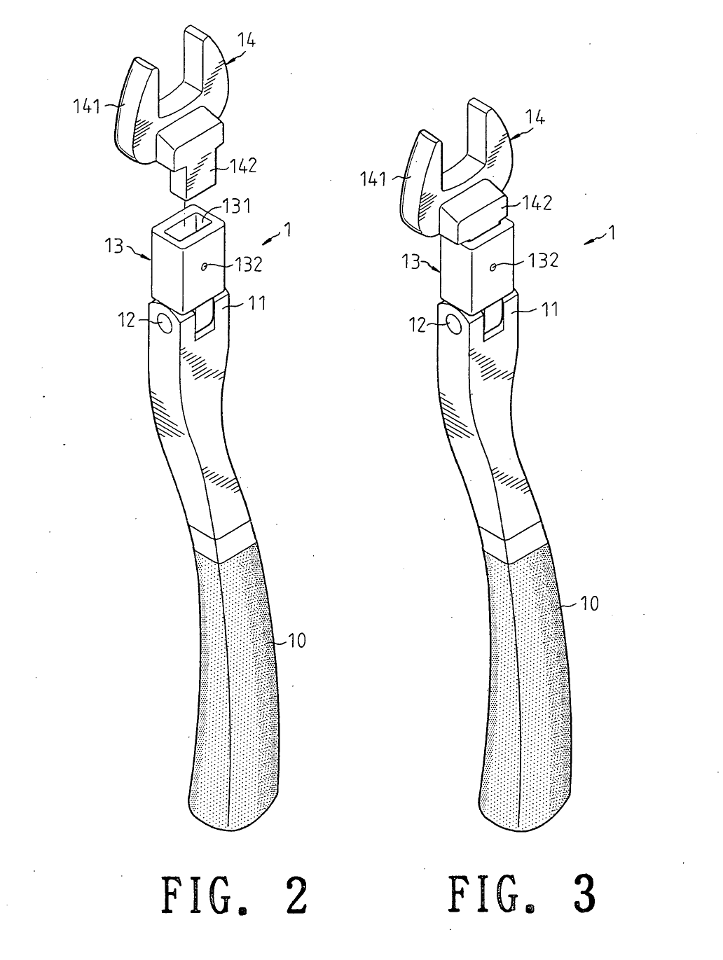

Referring to FIGS. 1 to 3, the hand tool 1 of the present invention comprises a handle 10 which has two lugs 11 extend from an end of the handle 10 and a connection end 13 includes a protrusion which is pivotably connected between the two lugs 11 by a pin 12. A polygonal recess 131 such as a rectangular recess is defined in the connection end 13.

A function end 14 has an insertion 142 which is removably inserted into the recess 131 of the connection end 13. The connection end 13 includes a positioning device 132 which positions the insertion 142 in the recess 131. The positioning device 132 can be a bead cooperated with a spring or a boss extending from an inside of the recess 131.

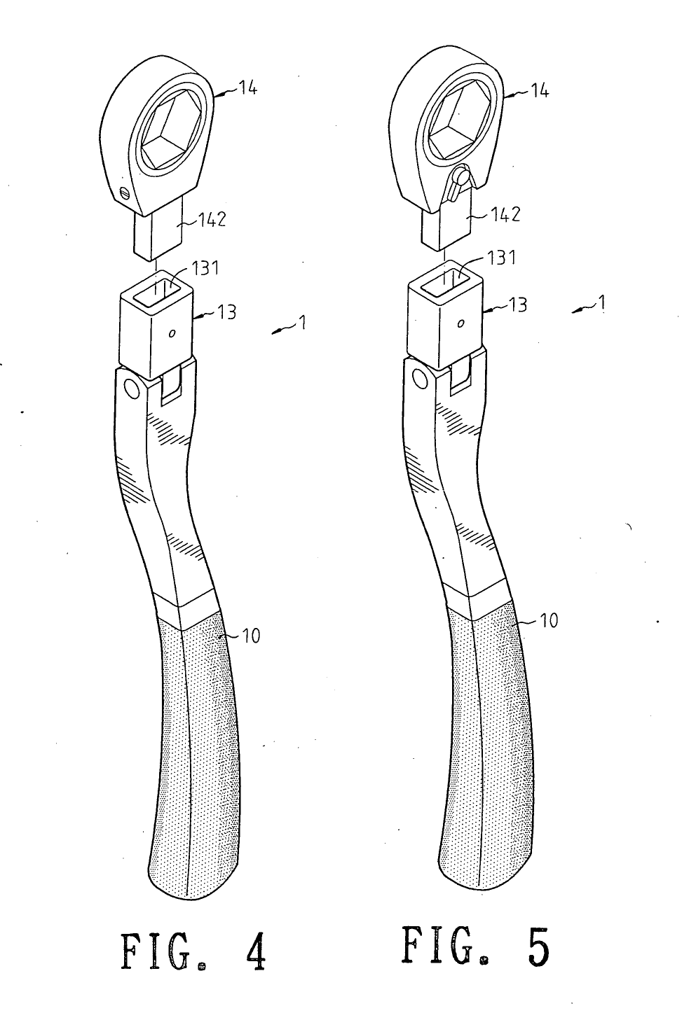

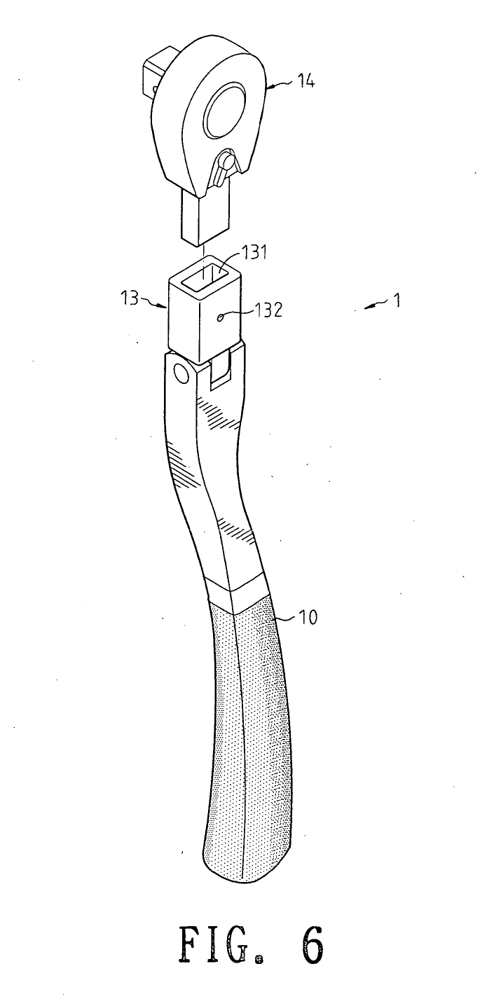

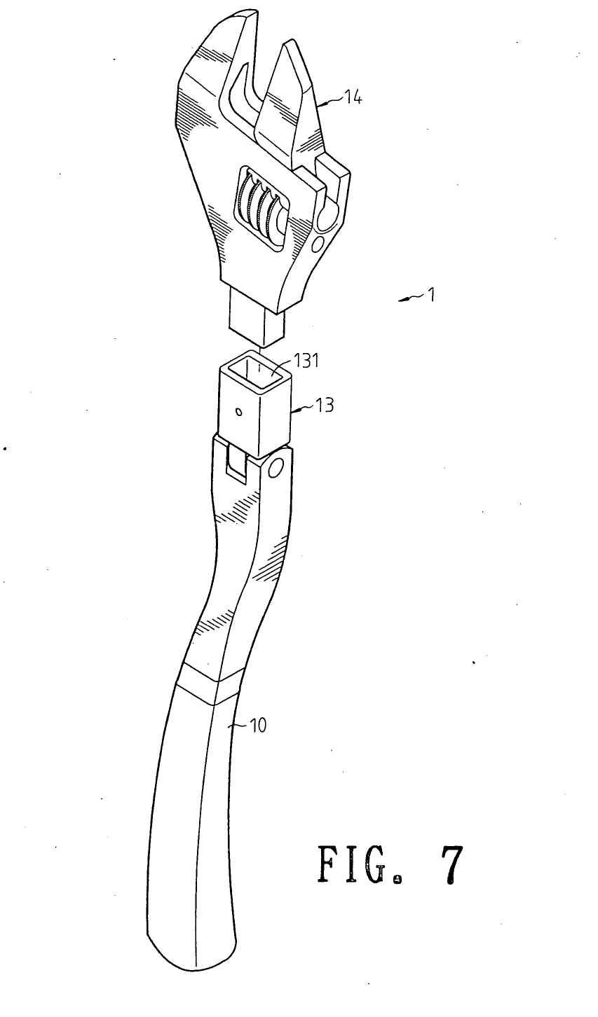

FIG. 4 shows that the function head 14 can be a box end or a ratchet box end as shown in FIG. 5. A ratchet driving head and an adjustable wrench can also be replaceably connected to the connection end.

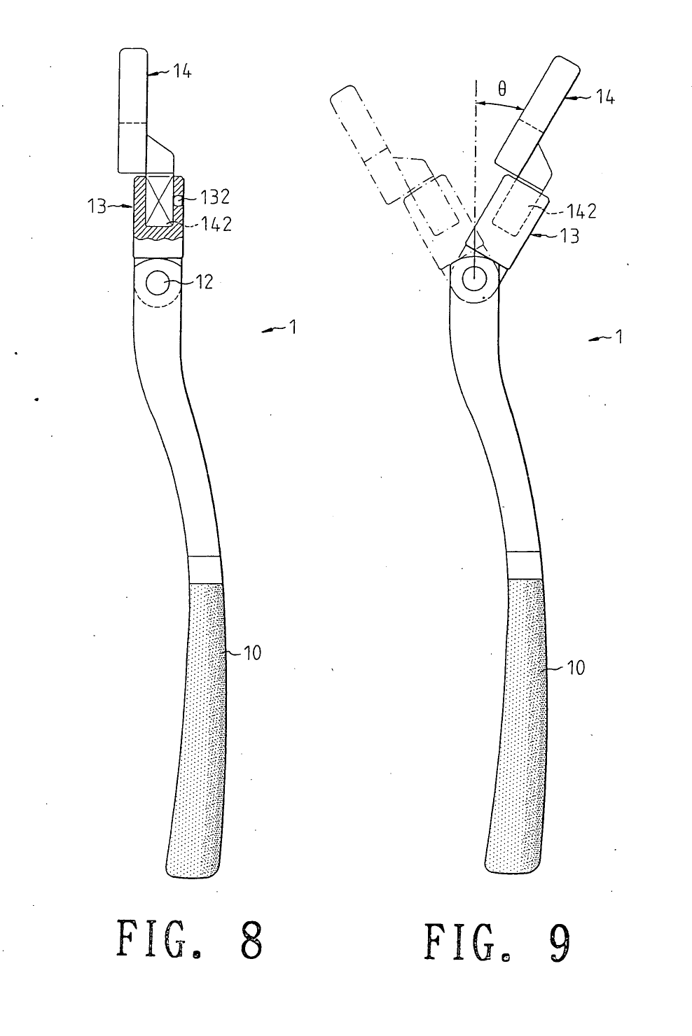

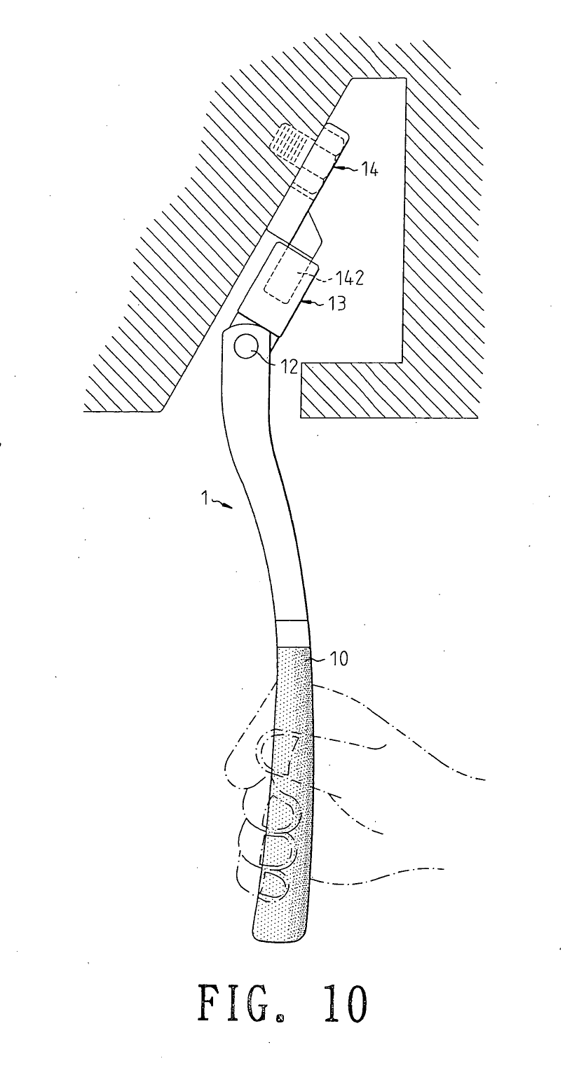

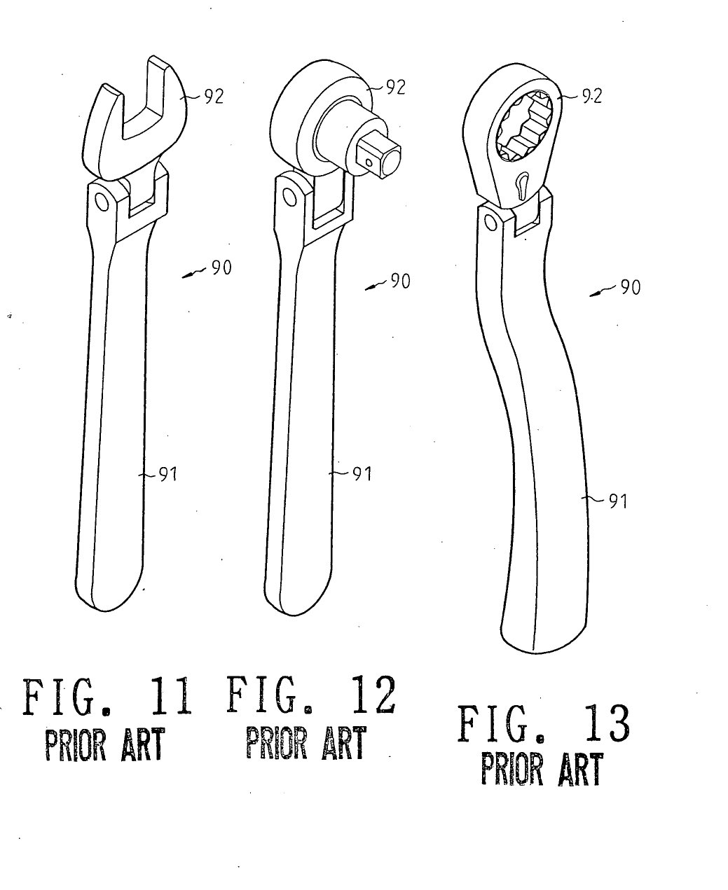

As shown in FIGS. 8 and 9, the function head 14 can be pivoted an angle “θ” relative to the handle 10 and this function allows the user to reach an object 14 located in a concavity conveniently as shown in FIG. 10.

While we have shown and described the embodiment in accordance with the present invention, it should be clear to those skilled in the art that further embodiments may be made without departing from the scope of the present invention.

1. A hand tool comprising:
a handle having two lugs extending from an end thereof and a connection end having a protrusion which is pivotably connected between the two lugs of the handle by a pin, a recess defined in the connection end and the connection end including a positioning device, and
a function end having an insertion which is removably inserted into the recess of the connection end and the insertion being positioned by the positioning device, the positioning device being a boss extending from an inside of the recess and contacting against a surface of the insertion.

2. (canceled)

3. (canceled)

4. The hand tool as claimed in claim 1, wherein the recess is a rectangular recess.
